(19) United States
(12) Patent Application Publication
(10) Pub. No.: US 2026/0300967 A1
(43) Pub. Date: Oct. 1, 2026

(54) SYSTEM AND METHODS FOR DIGITAL LIQUIDITY INSTRUMENTS

(71) Applicant: Michael A. Fesi, II, Houma, LA (US)

(72) Inventor: Michael A. Fesi, II, Houma, LA (US)

(21) Appl. No.: 19/578,001

(22) Filed: Mar. 25, 2026

Related U.S. Application Data
(60) Provisional application No. 63/777,870, filed on Mar. 26, 2025.

(51) Int. Cl. G06Q 20/38; G06Q 40/06

(52) U.S. Cl. CPC G06Q 20/389; G06Q 40/067

(57) ABSTRACT

A system and method for autonomous smart-contract-enforced dual-ledger state management of blockchain-based digital instruments. A smart contract module deployed on a permissioned blockchain network mints digital instruments each comprising on-chain metadata encoding an instrument-type identifier, a jurisdiction identifier, a maturity-condition set, a transaction-cycle counter, and a redemption-state flag. A dual-account ledger enforced by smart contract state variables maintains a first sub-ledger for active instrument circulation and a second sub-ledger for independent accumulation of transaction-derived value, wherein the segregation between sub-ledgers prevents accrual obligations from depleting active circulation liquidity at the protocol layer without human administrative intervention. A geofencing enforcement module validates each proposed transfer against permitted geographic jurisdictions using cross-source consistency analysis of a plurality of location-related inputs and prevents blockchain confirmation of transfers that fail jurisdictional validation. A transaction-processing module increments an on-chain cycle counter upon each qualifying transfer and allocates transaction-derived value to the second sub-ledger. Upon autonomous determination that all encoded maturity conditions are satisfied, the smart contract executes an atomic burn-to-unlock operation comprising token destruction, redemption-state flag transition, and second-sub-ledger balance release as a single irreversible blockchain transaction without human initiation. A data analytics and AI module autonomously recalibrates allocation ratios and circulation parameters based on real-time transaction and geographic data.

The present application claims priority to U.S. Provisional Application No. 63/777,870 filed Mar. 26, 2025, titled “SYSTEM AND METHODS FOR DIGITAL LIQUIDITY INSTRUMENTS” which is hereby incorporated by reference.

### TECHNICAL FIELD

The embodiments generally relate to systems and methods for a distributed smart contract architecture that enforces autonomous dual-ledger state segregation, geographically constrained multi-cycle token circulation, and programmable lifecycle management of blockchain-based digital instruments within a state-backed permissioned network.

### BACKGROUND

Traditional financial instruments such as government bonds, digital assets, and central bank digital currencies (CBDCs) have long served as tools for raising capital and maintaining liquidity in national and regional economies. However, these instruments often suffer from limited flexibility and fail to maintain continuous engagement with the economy. Conventional bonds tend to withdraw liquidity from circulation at maturity, while digital tokens and stablecoins frequently face challenges regarding speculative volatility and lack mechanisms to drive real-time economic participation and growth. This leads to inefficient capital utilization and a lack of alignment between investor returns and actual economic activity.

While some digital finance platforms have emerged that attempt to modernize capital deployment using blockchain technology and tokenized debt instruments, these systems typically focus on fixed-interest models or speculative trading. They often lack the capacity to ensure that invested funds remain actively employed in local economies or that yield generation dynamically reflects ongoing transaction activity. Moreover, these platforms frequently fail to offer meaningful participation opportunities for both institutional and retail investors in a unified ecosystem.

Furthermore, existing financial frameworks often lack mechanisms that ensure transparency, security, and controlled liquidity release. Many systems do not provide enforced geographic restrictions or multi-cycle transactional requirements that prioritize local economic development. Nor do they leverage state-backed stability to enhance investor confidence. The absence of a dual-account structure separating active liquidity from yield accrual limits these systems' ability to simultaneously stimulate economic activity and repay investors predictably.

Existing tokenized finance platforms and blockchain-based capital deployment systems do not provide a protocol-level mechanism for maintaining structural segregation between actively circulating instruments and independently accumulating accrual obligations. Where split-ledger or dual-account concepts exist in conventional systems, the segregation is implemented as an administrative policy applied by human operators to a general-purpose database or accounting system and remains subject to manual override, configuration change, or system administrator intervention. No existing system enforces dual-ledger segregation autonomously at the smart contract layer such that accrual obligations cannot deplete circulating liquidity as a matter of machine-enforced state, rather than human bookkeeping practice. Similarly, no existing system combines protocol-level geographic transaction validation using cross-source location consistency analysis with on-chain cycle-count enforcement and autonomous burn-to-unlock redemption in a single integrated smart contract architecture operating without human initiation of individual lifecycle transitions.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A system and method for smart-contract-enforced dual-ledger state management deploys blockchain-based digital instruments whose issuance, circulation, and redemption lifecycle is governed autonomously by smart contract logic executing on a permissioned blockchain network. Each digital liquidity instrument is initialized with machine-readable on-chain metadata comprising an instrument-type identifier, a jurisdiction identifier encoding one or more permitted geographic circulation zones, a maturity-condition set defining the conditions under which redemption becomes permissible, a transaction-cycle counter initialized to zero, and a redemption-state flag initialized to a non-redeemable state. No instrument may transition from a non-redeemable state to a redeemable state except through the execution of a burn-to-unlock operation triggered autonomously by the smart contract upon verified satisfaction of all encoded maturity conditions.

The system enforces a Dual-Account Ledger comprising two structurally and functionally distinct sub-ledgers maintained simultaneously by smart contract state variables. A first sub-ledger, the Circulating Token Pool, holds digital instruments in active circulation available for qualified transfers within designated geographic jurisdictions. A second sub-ledger, the Digital Accrual Account, independently accumulates transaction-derived value on behalf of each instrument holder as qualifying transfers occur. The smart contract architecture prevents the Digital Accrual Account from depleting liquidity in the Circulating Token Pool—the segregation is enforced at the protocol layer as a matter of machine-enforced state and is not subject to human administrative override after contract deployment. Upon satisfaction of all maturity conditions, the smart contract atomically executes a burn operation that destroys the circulating instrument, transitions the redemption-state flag, and releases the accumulated Digital Accrual Account balance in a single irreversible blockchain transaction without human initiation.

The system includes a geofencing enforcement module that validates each proposed transfer against one or more permitted geographic jurisdictions using a plurality of location-related data sources including global positioning system data, IP-based geolocation data, device identifier data, and merchant or counterparty registration data. Cross-source consistency analysis detects geographic evasion attempts including spoofing, proxy use, and synthetic routing at the protocol layer before blockchain confirmation. Transfers that fail jurisdictional validation are rejected and prevented from recording on the blockchain network. A transaction-processing module increments the on-chain transaction-cycle counter for each transfer that satisfies both jurisdictional validation and applicable circulation rules, and allocates a portion of transaction-derived value to the Digital Accrual Account independently of the instrument's continued active circulation. A data analytics and AI module continuously monitors transaction velocity, geographic distribution, and circulation patterns to autonomously recalibrate allocation ratios and risk thresholds without human initiation of individual adjustments.

Investors access the system through a web or mobile user interface that facilitates account creation, DLI purchases, transaction monitoring, and redemption requests. Smart contracts govern the entire lifecycle of DLIs, from issuance through redemption, reducing the need for manual intervention and increasing transparency. Both institutional and retail investors benefit from predictable, transaction-based yields that align with actual economic activity, ensuring fair and equitable participation across multiple tiers of investment.

In emergency economic scenarios or during market fluctuations, the system's integration with a state treasury ensures liquidity stability and investor confidence. The platform also includes data analytics and AI-driven modules that provide real-time insights into economic performance, enabling dynamic adjustments to yield distributions and risk controls. These features collectively establish a sustainable and adaptable digital economy that bridges traditional finance with modern blockchain technology.

In additional embodiments, the system may be applied beyond general economic stabilization to support targeted public initiatives. For example, Digital Liquidity Bonds (DLBs) may be issued by state or municipal governments to fund infrastructure projects such as transportation networks, renewable energy development, and broadband expansion. The system ensures that invested capital remains in active economic use throughout the construction lifecycle, while yields are generated and accrued based on transactional activity related to project expenditures.

Further use cases include the deployment of Digital Liquidity Rebates (DLRs) for disaster relief and recovery efforts, enabling rapid, controlled distribution of emergency liquidity to affected populations. The programmable enforcement of geo-fencing and multi-cycle usage ensures that aid capital remains within impacted zones, maximizing local economic recovery. In another embodiment, long-term DLBs may serve as state-subsidized instruments for education and workforce development, funding tuition assistance or vocational training while promoting economic circulation and return-on-investment through tracked yield generation.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of a computing system infrastructure upon which a system for managing Digital Liquidity Instruments may operate, including a processor, system bus, memory storing application instructions and data storage, input/output devices, a network interface, a user interface, a peripheral device interface, a network, a user computing device, an administrator computing device, a third-party computing device, and an application server configured to execute Digital Liquidity Instrument lifecycle operations, according to some embodiments.

FIG. 2 illustrates a block diagram of a DLI administration system architecture, including a User Interface, a Smart Contract Module, a Geofencing Enforcement Module, a Transaction Processing and Economic Intelligence Module, a Dual-Account Ledger comprising a Circulating Token Pool sub-ledger and a Digital Accrual Account sub-ledger, a Data Analytics and AI Module, a Blockchain Network, and a State Treasury Interface, according to some embodiments.

FIG. 3 illustrates a block diagram of a Digital Liquidity Bond system architecture configured for institutional instrument issuance and management, including a User Interface, a Smart Contract Module, a Maturity Horizon Configuration Module (316), a Capital Threshold Enforcer (318), a Geofencing Enforcement Module, a Transaction Processing and Economic Intelligence Module, a Dual-Account Ledger comprising a Circulating Token Pool and a Digital Accrual Account, a Blockchain Network, and a State Treasury Interface, according to some embodiments.

FIG. 4 illustrates a block diagram of a comprehensive Digital Liquidity Instrument system architecture supporting both Digital Liquidity Bond and Digital Liquidity Rebate instrument types, including a User Interface configured with a unified DLB and DLR dashboard, a Smart Contract Module, a Geofencing Enforcement Module, a Transaction Processing and Economic Intelligence Module, a Data Analytics and AI Module, a Dual-Account Ledger comprising a Circulating Token Pool and a Digital Accrual Account, a Blockchain Network, and a State Treasury Interface, according to some embodiments.

FIG. 5 is a flow diagram illustrating an example lifecycle process for issuance, circulation-state enforcement, maturity evaluation, and burn-to-unlock redemption of a Digital Liquidity Instrument, including steps for receiving an issuance request, validating participant permissions, initializing on-chain metadata comprising an instrument-type identifier, jurisdiction identifier, maturity-condition set, transaction-cycle counter, and redemption-state flag, minting the instrument, recording in the Dual-Account Ledger, activating circulation state, validating transactions against geographic and eligibility rules, incrementing the transaction-cycle counter, evaluating maturity conditions, and executing an atomic burn-to-unlock sequence upon satisfaction of all encoded maturity conditions, according to some embodiments.

FIG. 6 is a flow diagram illustrating an example process for smart-contract-enforced segregation of transaction-derived value between a Circulating Token Pool and a Digital Accrual Account within a Dual-Account Ledger, including steps for receiving a validated transaction event, extracting transaction attributes, invoking an allocation rules engine, determining an applicable allocation ratio, updating CTP and DAA balances, writing state updates to the smart contract ledger, generating audit and telemetry records, and evaluating whether recalibration of allocation parameters by the Data Analytics and AI Module is warranted, according to some embodiments.

FIG. 7 is a flow diagram illustrating an example process for multi-source geographic validation, jurisdictional compliance enforcement, and anomalous-circulation detection for Digital Liquidity Instrument transactions, including steps for collecting location and identity signals from multiple sources, normalizing source data, performing cross-source consistency analysis, evaluating jurisdictional compliance, performing participant authorization, detecting anomalous circulation patterns comprising circular transfers, affiliated-entity looping, velocity irregularities, and spoofing indicators, and either approving the transaction and incrementing the qualifying cycle counter or flagging the transaction and holding cycle-count advancement, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, Dual-Account Ledger (DAL) refers to a blockchain-enforced data architecture comprising two structurally and functionally distinct sub-ledgers—a Circulating Token Pool (CTP) and a Digital Accrual Account (DAA)—maintained in simultaneous operation by smart contract bytecode executing on a permissioned blockchain network, in which the segregation between sub-ledgers is enforced at the protocol level by smart contract state variables and is not subject to manual override, administrative adjustment, or human bookkeeping intervention after contract deployment.

As used herein, Burn-to-Unlock refers to an atomic smart contract operation that simultaneously destroys a circulating digital instrument, transitions its redemption-state flag from non-redeemable to redeemable, and releases an associated accrual balance from the Digital Accrual Account, executed as a single irreversible blockchain transaction upon satisfaction of all encoded maturity conditions.

As used herein, Transaction-Cycle Counter refers to an on-chain integer state variable, initialized at zero at instrument minting and incremented by one for each qualifying transaction that satisfies both jurisdictional validation and applicable circulation rules, maintained in the instrument's on-chain metadata on the blockchain network.

As used herein, Maturity-Condition Set refers to a machine-readable set of one or more encoded conditions that must each be satisfied before a burn-to-unlock operation may be executed, comprising any combination of a minimum transaction-cycle counter threshold, a time-based maturity timestamp, a geographic circulation threshold, and an accrued-value threshold.

As used herein, Maturity Horizon Configuration Module refers to a software module or smart contract function configured to initialize and enforce instrument-type-specific maturity parameters at the time of digital liquidity instrument minting, including a first maturity horizon applicable to DLBs and a second maturity horizon applicable to DLRs, each encoded as on-chain metadata within the instrument's maturity-condition set.

As used herein, Capital Threshold Enforcer refers to a software module or smart contract function configured to validate that a proposed instrument purchase satisfies a minimum capital threshold associated with the instrument type, wherein a first capital threshold is applicable to institutional DLB purchasers and a second capital threshold is applicable to retail DLR purchasers, and to prevent issuance when the proposed purchase amount fails to satisfy the applicable threshold.

In general, the embodiments disclosed herein relate to systems and methods for managing Digital Liquidity Instruments within a tokenized dual-account financial framework. A Digital Liquidity Instrument, or DLI, may be understood as a blockchain-based tokenized financial asset that represents a unit of invested capital within a state-backed digital economy. Each DLI may be issued programmatically through smart contract logic and may be associated with a defined set of lifecycle rules, including conditions for issuance, circulation, yield accrual, and redemption. DLIs may take two principal forms. A Digital Liquidity Bond, or DLB, may be configured as a long-term capital instrument designed for institutional investors, carrying an extended maturity horizon and structured yield parameters suited to large-scale capital deployment. A Digital Liquidity Rebate, or DLR, may be configured as a short-term participation instrument designed for retail investors, carrying a shorter maturity period and lower capital thresholds to encourage broad economic participation. Both DLBs and DLRs may circulate as tokens within a controlled digital economy and may generate yield for their holders based on transaction fees accrued during circulation rather than on fixed interest rates or speculative price appreciation.

A system for managing DLIs may comprise at least one user computing device configured to communicate over a network, and an application server in operable communication with the at least one user computing device over that network. The user computing device may be a desktop computer, a laptop computer, a tablet, a smartphone, or any other computing device capable of rendering a web-based or native application interface and transmitting data over a network such as the Internet, a local area network, a wide area network, or a combination thereof. The application server may comprise one or more processors coupled to a non-transitory computer-readable memory storing instructions that, when executed by the one or more processors, cause the application server to carry out the operations described herein. The one or more processors may include general-purpose microprocessors, multi-core processors, digital signal processors, application-specific integrated circuits, field-programmable gate arrays, or any combination thereof. The non-transitory computer-readable memory may include random access memory, read-only memory, flash memory, solid-state storage, magnetic disk storage, optical storage, or any suitable combination. The application server may be deployed as a single physical server, a cluster of servers, a cloud-based virtual machine instance, or a distributed computing environment, and may communicate with the user computing device through standard network protocols including TCP/IP, HTTP, HTTPS, Web Socket, or similar protocols.

The application server may provide a user interface accessible via the at least one user computing device. The user interface may be implemented as a web-based application served through a web browser, a native mobile application for iOS or Android operating systems, or a combination of both. The user interface may enable an investor to create a personalized account by submitting identification details, contact information, investment preferences, and any regulatory compliance data required under applicable financial regulations. Upon account creation, the user interface may present the investor with options to purchase one or more Digital Liquidity Instruments, including the selection of DLBs or DLRs based on the investor's capital capacity and investment horizon. The user interface may display available DLI offerings, each with associated parameters such as token denomination, expected yield range, maturity period, geographic circulation zone, and multi-cycle transaction requirements. The investor may select a DLI offering, specify a quantity or capital amount, and confirm the purchase through the user interface, at which point the application server may initiate the issuance workflow.

The user interface may further be configured to provide a unified dashboard displaying active DLB and DLR holdings, accrued yields, geographic allocation of tokens across one or more designated geographic jurisdictions, and remaining transaction cycle requirements for redemption eligibility. The dashboard may present real-time data visualizations, including charts of yield accrual over time, maps depicting the geographic distribution of circulating tokens, and progress indicators showing how many transaction cycles a given DLI has completed relative to the total required for redemption eligibility. Investors may use the dashboard to view transaction histories associated with their holdings, including timestamps, counterparty identifiers, transaction amounts, and the geographic coordinates or jurisdiction codes of each transaction. The user interface may also enable the investor to authorize third-party access for one or more designated individuals, including financial advisors, government regulators, or auditors, to view investment performance, yield accruals, and compliance data associated with the personalized account. Third-party access may be configured with granular permissions, such that an authorized party may view certain data elements without the ability to initiate transactions or modify account settings.

The application server may further provide a notification system that transmits alerts and updates to the user computing device confirming status changes associated with one or more Digital Liquidity Instruments. Status changes that may trigger notifications include transaction confirmations, yield accrual milestones, approaching maturity dates, multi-cycle completion events, and redemption eligibility transitions. Notifications may be delivered via the web interface as in-application alerts, via the mobile application as push notifications, or through external channels such as email or SMS. The investor may configure notification preferences through the user interface, selecting which types of events should generate alerts and through which delivery channels those alerts should be sent.

The system may include a Smart Contract Module that executes smart contract logic stored on a blockchain network. The Smart Contract Module may be a software component running on the application server that interfaces with one or more blockchain nodes to deploy, invoke, and monitor smart contracts. The blockchain network may be a permissioned blockchain, a public blockchain, or a hybrid configuration, and may use consensus mechanisms such as proof of stake, proof of authority, delegated proof of stake, or practical Byzantine fault tolerance to validate transactions and maintain an immutable ledger of all state changes. The smart contract logic may be written in a smart contract programming language such as Solidity, Vyper, Rust, or any other language supported by the target blockchain platform, and may be compiled into bytecode for execution on a blockchain virtual machine.

The Smart Contract Module may govern the issuance, lifecycle management, and redemption of DLIs. During issuance, the Smart Contract Module may receive a request from the application server indicating that an investor has purchased a DLI of a specified type, denomination, and parameter set. The Smart Contract Module may then execute a smart contract function that mints one or more tokens on the blockchain network, each token representing a DLI and carrying metadata that encodes the instrument's type (DLB or DLR), its maturity date, its associated geographic jurisdiction or jurisdictions, the number of transaction cycles required before redemption eligibility, and the initial yield parameters. The minting transaction may be recorded on the blockchain, creating an immutable record of the DLI's creation and its initial state. Once minted, each DLI token may be assigned to the investor's blockchain wallet address, which may be linked to the investor's personalized account within the application server.

The Smart Contract Module may enforce geo-fencing restrictions that require tokens associated with DLIs to circulate within one or more designated geographic jurisdictions. Geo-fencing enforcement may operate through real-time transaction location validation, wherein each transaction involving a DLI token is evaluated against a set of permitted geographic boundaries before the transaction is confirmed on the blockchain. The geographic location of a transaction may be determined by the reported location of the participating user computing devices, by the registered address of the merchant or counterparty involved in the transaction, by GPS coordinates transmitted by mobile devices, by IP address geolocation, or by a combination of these methods. If a transaction is determined to originate from or be directed to a location outside the designated geographic jurisdiction for a given DLI, the smart contract logic may reject the transaction and prevent it from being recorded on the blockchain. The Smart Contract Module may additionally perform geographic-based token velocity tracking, which monitors the rate at which tokens circulate within each designated geographic jurisdiction over a given time period. Token velocity data may be stored on-chain or in an off-chain database accessible to the Smart Contract Module, and may be used to assess whether tokens are circulating at a rate consistent with genuine economic activity within the jurisdiction.

The Smart Contract Module may also enforce multi-cycle transaction requirements that require each DLI token to participate in a predefined number of economic transaction cycles before the token becomes eligible for redemption. A transaction cycle may be defined as one complete transfer of a token from one participant to another within the ecosystem in exchange for goods, services, or other economic value. The smart contract logic may maintain a counter for each DLI token that increments each time the token completes a qualifying transaction. A qualifying transaction may be one that satisfies both the geo-fencing restrictions and any minimum transaction value thresholds defined in the smart contract parameters. When the counter for a given token reaches the predefined number of required cycles, the smart contract may update the token's metadata to reflect that it has satisfied the multi-cycle requirement. Until this requirement is met, the token may remain in a non-redeemable state, ensuring that capital continues to circulate within the economy.

The Smart Contract Module may execute a burn-to-unlock mechanism that operates as a controlled redemption process tied to predefined maturity conditions. The predefined maturity conditions may include the passage of a specified time period from the date of issuance, the completion of the required number of multi-cycle transactions, satisfaction of any geographic circulation thresholds, or a combination of these conditions. When the Smart Contract Module determines that all predefined maturity conditions for a given DLI have been satisfied, the burn-to-unlock mechanism may be triggered. The burn-to-unlock mechanism may involve executing a smart contract function that destroys or burns the DLI token on the blockchain, thereby removing it from circulation, and simultaneously unlocking or releasing the corresponding accrued yield and, where applicable, the original capital value from the Digital Accrual Account. The burned token's final state may be recorded on the blockchain as an immutable record that the instrument has been fully redeemed. Upon completion of the burn-to-unlock process, the application server may credit the investor's account with the redeemed value and may transmit a notification confirming the redemption event.

The system may manage a Dual-Account Ledger, referred to as the DAL, which comprises two distinct sub-ledgers: a Circulating Token Pool and a Digital Accrual Account, referred to as the DAA. The Dual-Account Ledger may be implemented as a combination of on-chain data structures maintained by smart contracts and off-chain database records maintained by the application server, or it may be implemented entirely on-chain, depending on the performance and storage requirements of the deployment. The Circulating Token Pool may hold all DLI tokens that are currently in active economic circulation, meaning they are available for use in transactions between participants in the ecosystem. When an investor purchases a DLI, the corresponding token may be minted and placed into the Circulating Token Pool, where it becomes available for transfer and use in commerce. As tokens circulate and are used in transactions, a portion of each transaction fee generated by those transactions may be allocated to the Digital Accrual Account. The Digital Accrual Account may serve as a yield storage ledger that accumulates transaction-based returns on behalf of each investor. Rather than distributing yields in real time as each transaction occurs, the Digital Accrual Account may accumulate yields over the lifecycle of each DLI and make them available upon maturity and redemption through the burn-to-unlock mechanism. The segregation of the Circulating Token Pool from the Digital Accrual Account may ensure that investor yields do not reduce the liquidity available for economic transactions, and that circulating capital is not prematurely withdrawn from the economy to satisfy yield payments.

In some embodiments, each digital liquidity instrument minted by the Smart Contract Module may be represented as a structured on-chain data record comprising a defined set of state variables maintained within the smart contract storage of the blockchain network. The on-chain record for each instrument may include at least the following fields: (i) an instrument-type identifier comprising a machine-readable enumeration value distinguishing a first instrument type from a second instrument type based on configurable maturity parameters; (ii) a jurisdiction identifier comprising one or more geographic boundary descriptors, polygon coordinates, or jurisdiction code values encoding the permitted circulation zone or zones for the instrument; (iii) a maturity-condition set comprising one or more encoded conditions each associated with a condition type, a threshold value, and a satisfaction flag, wherein the condition types may include a minimum transaction-cycle threshold, a time-based maturity timestamp, a geographic circulation threshold, and an accrued-value threshold; (iv) a transaction-cycle counter comprising an on-chain integer initialized to zero at instrument minting and incremented by the smart contract upon each qualifying transaction event that satisfies both jurisdictional validation and applicable circulation rules; (v) a redemption-state flag comprising a boolean or enumeration state variable initialized to a non-redeemable state at minting and transitionable to a redeemable state exclusively through execution of the burn-to-unlock mechanism; and (vi) a Digital Accrual Account pointer or reference comprising an identifier linking the instrument's on-chain record to the corresponding balance entry in the second sub-ledger of the Dual-Account Ledger.

The Dual-Account Ledger may be implemented using two structurally distinct sets of on-chain state variables maintained within the smart contract storage. The first sub-ledger, comprising the Circulating Token Pool, may be implemented as a mapping data structure associating each instrument identifier with a circulation-state record comprising the instrument's current holder address, the current transaction-cycle counter value, and the current redemption-state flag value. The second sub-ledger, comprising the Digital Accrual Account, may be implemented as a separate mapping data structure associating each instrument identifier or instrument holder address with an accrued balance value denominated in a unit of account corresponding to the transaction-derived value accumulated through qualifying transfers. The smart contract logic may enforce that write operations to the Digital Accrual Account mapping and write operations to the Circulating Token Pool mapping are executed independently such that an increment to the Digital Accrual Account balance does not trigger any reduction to the Circulating Token Pool balance, and a transfer of an instrument within the Circulating Token Pool does not trigger any release or reduction of the corresponding Digital Accrual Account balance. This structural independence is enforced at the smart contract layer as a consequence of the separate mapping architecture and cannot be circumvented by any system participant, administrator, or treasury entity after contract deployment on the blockchain network.

The burn-to-unlock mechanism may be implemented as a smart contract function that, upon invocation following autonomous verification that all conditions in the maturity-condition set have been satisfied, executes the following operations within a single atomic blockchain transaction: (a) deletes or deactivates the instrument's entry in the Circulating Token Pool mapping, removing the instrument from active circulation and preventing any further transfer operations from being confirmed on the blockchain; (b) updates the redemption-state flag in the instrument's on-chain record from the non-redeemable enumeration value to the redeemable enumeration value, creating an immutable on-chain record of the state transition; and (c) transfers the accumulated balance from the Digital Accrual Account mapping entry associated with the instrument to a designated redemption address or settlement ledger entry specified by the instrument holder. The atomicity of this operation is enforced by the blockchain network's transaction execution model, under which all three state changes are committed together or none are committed, such that no partial execution state is possible. The completed burn-to-unlock transaction is recorded on the blockchain as an immutable, auditable event that no subsequent operation can reverse or modify.

The Dual-Account Ledger may dynamically segregate tokens between the Circulating Token Pool and the Digital Accrual Account in response to real-time economic data and transaction volumes. This dynamic segregation may be facilitated by a Taxation and Transaction Processing Module, which may be a software module executing on the application server or as a set of smart contract functions on the blockchain. The Taxation and Transaction Processing Module may process each transaction that occurs within the ecosystem by calculating the applicable transaction fee, determining the portion of the fee to be allocated as yield to the Digital Accrual Account, and distributing any applicable taxes or regulatory fees to the appropriate government revenue accounts. The allocation ratios between the Circulating Token Pool and the Digital Accrual Account may be adjusted based on real-time economic data, such as aggregate transaction volume, average transaction value, the number of active tokens in circulation, and economic indicators reported by the Data Analytics and Artificial Intelligence Module. For example, if transaction volumes within a given jurisdiction are increasing, the Taxation and Transaction Processing Module may allocate a higher proportion of fees to the Digital Accrual Account to increase investor yields, or it may retain a higher proportion in the Circulating Token Pool to support increased economic activity, depending on the policy parameters configured by the system administrators.

The system may interface with a state treasury system to maintain a one-to-one peg between circulating tokens in the Circulating Token Pool and fiat currency reserves held by the state treasury system. The interface with the state treasury system may be implemented through a Government Revenue Interface, which may be a secure application programming interface or a set of encrypted communication channels between the application server and the treasury's financial management systems. The Government Revenue Interface may transmit data regarding the total number of tokens in circulation, the aggregate value of the Circulating Token Pool, and the current balance of the Digital Accrual Account. In return, the state treasury system may confirm that sufficient fiat reserves are held to back each circulating token at a one-to-one ratio. If a discrepancy is detected, the Government Revenue Interface may trigger corrective actions, such as minting additional tokens backed by newly deposited fiat reserves, or burning excess tokens to bring the ratio back into alignment. This state-backed fiat peg may provide stability to the value of circulating tokens, reducing the risk of speculative volatility and enhancing investor confidence. In emergency economic scenarios or during market fluctuations, the state treasury interface may enable rapid liquidity injections or controlled token burns to maintain economic stability within the ecosystem.

The system may incorporate a Data Analytics and Artificial Intelligence Module that continuously monitors transaction activity and geographic token circulation in real time. The Data Analytics and Artificial Intelligence Module may be implemented as a set of machine learning models, statistical analysis engines, and data processing pipelines running on the application server or on dedicated compute infrastructure. The module may ingest data from the blockchain network, including transaction records, token transfer events, smart contract state changes, and block timestamps. It may also ingest off-chain data, such as economic indicators, geographic activity reports, and market conditions. Using this data, the Data Analytics and Artificial Intelligence Module may dynamically adjust yield parameters distributed to the Digital Accrual Account based on transaction velocity and volume data within the tokenized dual-account financial framework. Transaction velocity may be measured as the number of times a token changes hands within a defined time window, and transaction volume may be measured as the aggregate value of all transactions processed within a defined time window or geographic jurisdiction.

The Data Analytics and Artificial Intelligence Module may further perform risk-adjusted yield enforcement using predictive analytics. Predictive analytics may involve the application of machine learning models, including regression models, time-series forecasting models, neural networks, or ensemble methods, that are trained on historical transaction data and economic indicators to forecast future transaction volumes, token velocity trends, and potential economic risks. Based on these forecasts, the module may recalibrate yield distribution thresholds to account for anticipated changes in economic activity within the one or more designated geographic jurisdictions. For instance, if the predictive model forecasts a decline in transaction volume within a particular jurisdiction, the module may proactively reduce the yield accrual rate for DLIs circulating in that jurisdiction to ensure that yield obligations remain sustainable. Conversely, if the model forecasts increased activity, the module may increase the accrual rate to align investor returns with actual economic performance. The recalibration of yield parameters based on transactional volume may be performed separately from the risk-adjusted yield enforcement using predictive analytics, allowing the system to respond to both observed and anticipated conditions.

The system may generate alerts related to yield distribution thresholds and compliance metrics. The Data Analytics and Artificial Intelligence Module may continuously evaluate token circulation patterns against the multi-cycle transaction requirements and the geo-fencing restrictions to identify tokens that are approaching redemption eligibility, tokens that may be at risk of non-compliance, and tokens exhibiting anomalous circulation patterns that may indicate fraudulent activity or systemic risk. When such conditions are detected, the module may generate alerts for system administrators, regulators, or the affected investors, depending on the nature of the alert. The alerts may be delivered through the same notification channels available to investors, including web interface alerts, push notifications, email, and SMS.

An investor may initiate a redemption request through the user interface. Upon receiving the redemption request, the application server may verify that the predefined maturity conditions and the multi-cycle transaction requirements have been satisfied for the Digital Liquidity Instrument identified in the request. Verification may involve querying the blockchain network to confirm the token's transaction cycle counter, maturity date, and geographic circulation history, as well as querying the Dual-Account Ledger to confirm the accrued yield balance in the Digital Accrual Account. If all conditions are verified, the application server may invoke the burn-to-unlock mechanism through the Smart Contract Module, which may destroy the token on the blockchain and release the corresponding accrued yield from the Digital Accrual Account to the investor's account. If the conditions have not been satisfied, the application server may notify the investor of the outstanding requirements and may display on the unified dashboard the specific conditions that remain unfulfilled.

The system may support multi-tiered investment participation by enabling a variety of investors, including both institutional and retail participants, to purchase and manage DLIs within the same infrastructure. Institutional investors may subscribe to DLBs that carry longer maturity periods, higher capital requirements, and potentially different yield parameters than DLRs. Retail investors may purchase DLRs with shorter maturity periods, lower capital thresholds, and yield parameters calibrated for smaller-scale participation. Both DLBs and DLRs may circulate within the same Circulating Token Pool, may be subject to the same geo-fencing restrictions and multi-cycle transaction requirements, and may generate yields that are deposited into each investor's respective Digital Accrual Account. The unified dashboard may consolidate the investor's entire portfolio, displaying both DLB and DLR holdings alongside their respective yield accruals, cycle completion status, and geographic allocation data.

The system may be applied to support targeted public initiatives beyond general economic stabilization. DLBs may be issued by state or municipal governments to fund public infrastructure projects such as transportation networks, renewable energy development, and broadband expansion. In such embodiments, the geo-fencing restrictions may be configured to ensure that invested capital circulates within geographic areas associated with the infrastructure project, and the multi-cycle transaction requirements may be calibrated to ensure that tokens remain in active economic use throughout the construction lifecycle. DLRs may be deployed for disaster relief and recovery efforts, enabling rapid and controlled distribution of emergency liquidity to affected populations. In such embodiments, the programmable enforcement of geo-fencing restrictions may ensure that aid capital remains within impacted zones, and the multi-cycle transaction requirements may be adjusted to maximize local economic recovery by encouraging multiple rounds of spending within the affected area. DLBs may also serve as state-subsidized instruments for education and workforce development, funding tuition assistance or vocational training programs. In such embodiments, yields may be generated and accrued based on transactional activity related to educational expenditures, and the system may track return on investment through the yield generation data stored in the Digital Accrual Account.

The blockchain network underlying the system may serve as the distributed ledger for recording all transactions, validating smart contract execution, and maintaining an immutable history of state changes within the ecosystem. Each transaction involving a DLI token may be recorded as a block entry on the blockchain, including the sender and receiver wallet addresses, the transaction value, the timestamp, the geographic jurisdiction code, and any associated metadata such as the token's current cycle count. The blockchain may provide transparency, as all participants and authorized regulators may inspect the transaction history of any token. The blockchain may also provide security, as the use of cryptographic hashing and consensus mechanisms may make it computationally infeasible to alter historical transaction records. The system may interact with the blockchain network through remote procedure call interfaces, WebSocket connections, or blockchain-specific APIs exposed by the blockchain nodes.

The application server may be implemented using a combination of software components, including a web server for handling HTTP and HTTPS requests, an application framework for processing business logic, a database management system for storing off-chain data, and a blockchain interface layer for communicating with the blockchain network. The application server may use a relational database, a NoSQL database, or a combination thereof to store investor account data, notification preferences, dashboard configurations, off-chain yield calculation caches, and system administration settings. The application server may be deployed in a cloud computing environment using Infrastructure as a Service, Platform as a Service, or Software as a Service models, and may leverage containerization and orchestration technologies to scale horizontally in response to increased user demand or transaction volume.

The memory of the application server may store computer-readable application instructions configured to implement the various embodiments described herein. The application instructions may be implemented using any suitable programming language or combination of programming languages, including but not limited to Java, Python, JavaScript, TypeScript, C++, C#, Go, Rust, or similar languages. The application instructions may execute entirely on the application server, partly on the application server and partly on the user computing device, or may be distributed across multiple servers in a cloud computing environment. The computer-readable storage medium on which the instructions are stored may be a tangible, non-transitory device that retains and stores instructions for use by the one or more processors, and may include electronic storage devices, magnetic storage devices, optical storage devices, electromagnetic storage devices, semiconductor storage devices, or any suitable combination thereof. The instructions may be downloaded to the application server from a remote computer or storage device via the network.

The network over which the user computing device and the application server communicate may correspond to a local area network, a wide area network, the Internet, a virtual private network, or any combination thereof. The network may comprise copper transmission cables, optical transmission fibers, wireless transmission links, routers, firewalls, switches, gateway computers, and edge servers. Communication between the user computing device and the application server may be encrypted using transport layer security or similar protocols to protect the confidentiality and integrity of data in transit. Communication between the application server and the blockchain network may be conducted through dedicated network connections or through public network endpoints exposed by the blockchain nodes, and may similarly be encrypted to prevent unauthorized interception.

Various implementations of the invention involve the technical field of distributed smart contract architectures for autonomous dual-ledger state segregation including receiving, by one or more processors of an application server, a request from a user computing device to create an investor account and to purchase one or more Digital Liquidity Instruments, wherein the one or more Digital Liquidity Instruments comprise at least one of a Digital Liquidity Bond (DLB) configured as a long-term capital instrument and a Digital Liquidity Rebate (DLR) configured as a short-term participation instrument; issuing, by the one or more processors via a Smart Contract Module executing smart contract logic on a blockchain network, the one or more Digital Liquidity Instruments, and recording the issuance on the blockchain network; segregating, by the one or more processors, capital associated with the issued Digital Liquidity Instruments into a Dual-Account Ledger (DAL) comprising a Circulating Token Pool configured to maintain tokens in active economic circulation and a Digital Accrual Account (DAA) configured to accumulate investor yield derived from transaction fees; enforcing, by the one or more processors via the smart contract logic, geo-fencing restrictions requiring the tokens to circulate within one or more designated geographic jurisdictions; enforcing, by the one or more processors via the smart contract logic, multi-cycle transaction requirements requiring the tokens to complete a predefined number of economic transaction cycles before becoming eligible for redemption; accumulating, by the one or more processors, transaction-based yield in the Digital Accrual Account as the tokens circulate within the Circulating Token Pool; and executing, by the one or more processors, a burn-to-unlock mechanism that, upon determination that predefined maturity conditions have been satisfied for a Digital Liquidity Instrument, automatically converts the Digital Liquidity Instrument from a non-redeemable state to a redeemable state and are therefore necessarily rooted in computer technology. For example, the aforementioned steps are inherently computer-based and cannot be performed in the human mind. The disclosed system amounts to more than merely implementing the generic computer as a tool to gather, analyze, and output data because the steps of the present method, system, or product improve the field of tokenized dual-account financial frameworks by programmatically maintaining active capital circulation within targeted local economies while simultaneously and independently accumulating transaction-derived investor yield, all without human administrative intervention at the transaction level. Traditional government bonds withdraw liquidity from circulation upon maturity, stablecoins lack enforcement mechanisms that tie token movement to genuine regional economic activity, and existing tokenized debt platforms rely on fixed-interest models decoupled from actual transactional throughput. The DLI system overcomes these deficiencies through a particular machine-level architecture, the Dual-Account Ledger, that automatically segregates circulating tokens from accrued yields within the ledger structure itself, so that yield obligations never deplete the liquidity pool available for commerce and circulating capital is never prematurely extracted to satisfy investor returns. This segregation is not a business policy applied by a human bookkeeper to a spreadsheet or general-purpose database; it is enforced in real time by smart contract bytecode executing on a blockchain virtual machine, where each DLI token carries machine-readable metadata encoding its transaction cycle counter, geographic jurisdiction code, maturity timestamp, and redemption state flag, and where every proposed transaction is validated against geo-fencing coordinates and cycle completion thresholds before the blockchain consensus mechanism will confirm it.

The system goes beyond organizing human activity on generic hardware because each of its functional modules performs a technological function that has no manual analog. The Smart Contract Module does not merely record a human decision to approve or deny a transaction; it autonomously evaluates location data, increments on-chain cycle counters, and executes the burn-to-unlock mechanism, a defined sequence of token destruction, state transition from non-redeemable to redeemable, and yield release, without any human triggering the redemption logic. The Geo-fencing Enforcement Module performs real-time transaction location validation by comparing GPS coordinates, IP geolocation data, or registered counterparty addresses against jurisdiction boundary polygons stored in the smart contract, and independently rejects non-compliant transactions at the protocol level before they reach the ledger. The Data Analytics and Artificial Intelligence Module ingests on-chain transaction records and off-chain economic indicators into machine learning pipelines, including time-series forecasting models and regression engines, that autonomously recalibrate yield distribution thresholds and token allocation ratios between the Circulating Token Pool and the Digital Accrual Account, a feedback loop that operates continuously and without human initiation. The Taxation and Transaction Processing Module computes fee allocations, tax distributions, and dynamic ledger segregation ratios on every transaction in real time, routing fractional token values between sub-ledgers at a speed and granularity that no human process could replicate. Taken together, these modules constitute an integrated, self-governing computational architecture in which the blockchain, the smart contracts, the dual-ledger data structures, and the AI-driven analytics engine interact to produce a technical result, sustained, geographically constrained, multi-cycle token circulation with autonomous yield accrual and controlled redemption, that is rooted in the specific configuration and interoperation of software and hardware components rather than in the abstract organization of economic relationships.

Additionally, the steps of the disclosed system would be impossible to accomplish on pen and paper due to the volume of data being communicated and received over a network in real-time. In particular, the speed at which the steps of the disclosed system occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the disclosed system include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the disclosed system would be impossible to accomplish on pen and paper or in the human mind due to the volume of data being analyzed and transformed by the artificial intelligence model.

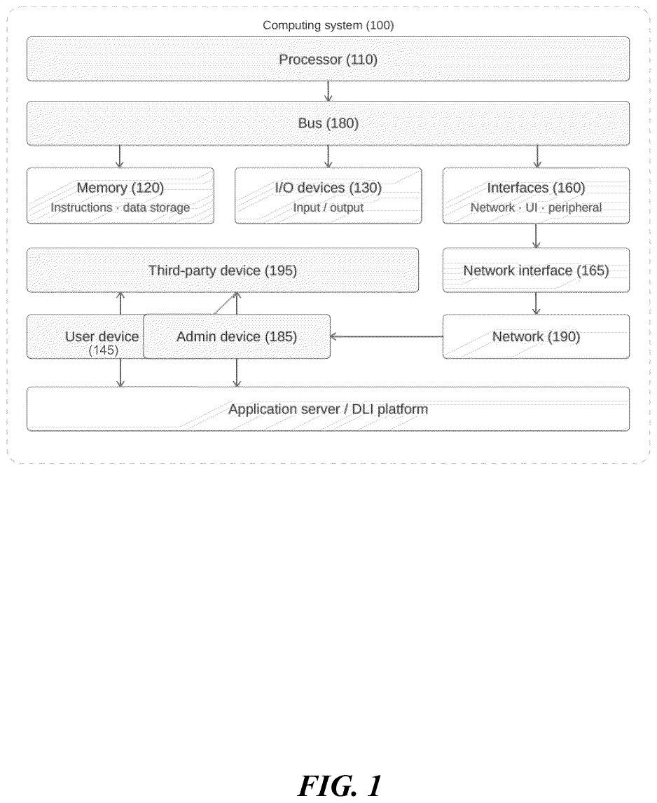

Referring to FIG. 1, a block diagram of a computing system 100 is shown, according to some embodiments. The computing system 100 may serve as the underlying hardware and network infrastructure upon which a system for managing Digital Liquidity Instruments operates. The computing system 100 may comprise a standalone computer, a mobile computing device, a mainframe computer system, a workstation, a network computer, a desktop computer, a laptop, or any combination thereof. The computing system 100 may also be embedded in another device, such as a mobile telephone, a personal digital assistant, a mobile audio or video player, a game console, a Global Positioning System receiver, or a portable storage device such as a universal serial bus flash drive.

Still referring to FIG. 1, the computing system 100 may include one or more processors 110 coupled to a memory 120 through a system bus 180. The system bus 180 may couple various system components, including input/output devices 130, to the one or more processors 110. The bus 180 may be any of several types of bus structures, including a memory bus, a memory controller bus, a peripheral bus, and a local bus using any of a variety of bus architectures such as Industry Standard Architecture, Micro Channel Architecture, Enhanced Industry Standard Architecture, Video Electronics Standards Association local bus, or Peripheral Component Interconnect bus. The one or more processors 110 may include general-purpose microprocessors, special-purpose microprocessors, digital signal processors, multi-core processors, application-specific integrated circuits, field-programmable gate arrays, or any combination thereof suited to execute computer-readable program instructions that implement the operations described herein. The one or more processors 110 may be a single processing unit or a plurality of processing units, and may include single or multiple computing units or multiple processing cores configured to fetch and execute instructions stored in the memory 120.

Still referring to FIG. 1, the memory 120 may store application instructions 140 and a data storage component 150. The application instructions 140 may comprise software elements configured to implement the various embodiments described herein, including the Smart Contract Module, the Dual-Account Ledger management logic, geo-fencing enforcement routines, multi-cycle transaction tracking algorithms, burn-to-unlock redemption processes, and the Data Analytics and Artificial Intelligence Module. The application instructions 140 may be implemented using any suitable programming language or combination of programming languages, including but not limited to Java, Python, JavaScript, TypeScript, C++, C#, Go, Rust, Solidity, or similar languages. The data storage component 150 may comprise one or more databases or data stores that maintain investor account records, DLI metadata, transaction histories, yield accrual balances, geo-fencing jurisdiction definitions, multi-cycle counter states, notification preferences, dashboard configurations, and system administration settings. The data storage component 150 may be implemented using relational database management systems, NoSQL databases, distributed ledger data structures, or any combination thereof.

Still referring to FIG. 1, the computing system 100 may include one or more input/output devices 130, such as video devices including cameras, audio devices, and displays, in operable communication with the computing system 100. The input/output devices 130 may be integrated into the computing system 100 or may be separate devices that interact with one or more nodes of the computing system 100 through wired or wireless connections over a network interface. The computing system 100 may include one or more interfaces 160 that allow the computing system 100 to interact with other systems, devices, or computing environments. The interfaces 160 may include a network interface 165, a user interface 170, and a peripheral device interface 175. The network interface 165 may be configured to allow data to be exchanged between the computing system 100 and other devices attached to a network 190, such as other computer systems, blockchain nodes, or state treasury systems. The network interface 165 may support communication via wired or wireless general data networks, such as Ethernet, telecommunications and telephony networks, fiber communications networks, storage area networks, or any other suitable type of network and protocol. The user interface 170 may provide the graphical or text-based interface through which investors, administrators, and regulators interact with the system for managing Digital Liquidity Instruments. The peripheral device interface 175 may facilitate connections to external hardware components, such as printers, scanners, hardware security modules, or biometric authentication devices that may be used in conjunction with the system.

Still referring to FIG. 1, the network 190 may correspond to a local area network, a wide area network, the Internet, a direct peer-to-peer network such as device-to-device Wi-Fi or Bluetooth, or an indirect peer-to-peer network in which devices communicate through a server, router, or other network device. The network 190 may comprise copper transmission cables, optical transmission fibers, wireless transmission links, routers, firewalls, switches, gateway computers, and edge servers. The computing system 100 may further include a user computing device 145, an administrator computing device 185, and a third-party computing device 195, each in communication via the network 190. The user computing device 145 may be operated by an investor to access the user interface, create a personalized account, purchase Digital Liquidity Instruments including Digital Liquidity Bonds and Digital Liquidity Rebates, monitor transaction histories and yield accruals through a unified dashboard, and submit redemption requests. The administrator computing device 185 may be utilized by an administrative user to moderate content, configure system parameters such as geo-fencing jurisdiction boundaries, multi-cycle transaction thresholds, and yield distribution rules, and to perform other administrative functions related to the management of the Digital Liquidity Instrument ecosystem. The third-party computing device 195 may be utilized by third parties, including financial advisors, government regulators, auditors, or state treasury officials, to receive communications from the user computing device 145, transmit communications to the user via the network 190, view investment performance and compliance data under authorized third-party access permissions, and otherwise interact with the various functionalities of the system.

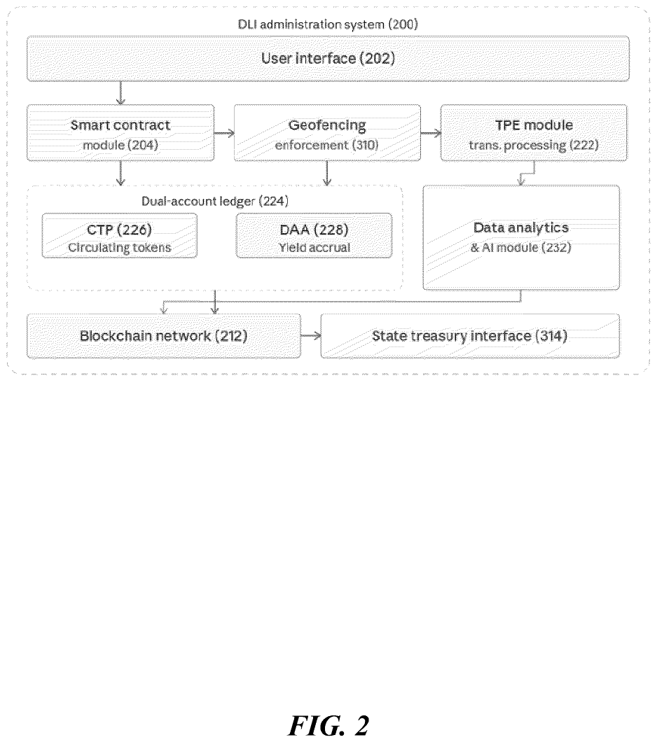

Referring now to FIG. 2, a block diagram of a DLI administration system 200 is shown, according to some embodiments. The DLI administration system 200 represents the logical arrangement of software modules and data structures executing on the computing system 100 described with reference to FIG. 1, and serves as the principal architecture for administering the issuance, circulation, enforcement, yield accrual, and redemption of Digital Liquidity Instruments within a state-backed permissioned blockchain environment. FIG. 2 depicts a User Interface 202, a Smart Contract Module 204, a Geofencing Enforcement Module 310, a Transaction Processing and Economic Intelligence Module 222, a Dual-Account Ledger 224 comprising a Circulating Token Pool 226 and a Digital Accrual Account 228, a Data Analytics and AI Module 232, a Blockchain Network 212, and a State Treasury Interface 314. These components may communicate through application programming interfaces, message queues, remote procedure calls, blockchain transaction submissions, or any other suitable inter-module communication mechanism.

Still referring to FIG. 2, the User Interface 202 is positioned at the top of the DLI administration system 200 and serves as the primary point of interaction for investors, including both institutional and retail participants. The User Interface 202 may be implemented as a web-based application, a native mobile application for iOS or Android operating systems, or a combination of both. The User Interface 202 enables investors to create personalized accounts, browse available Digital Liquidity Instrument offerings, purchase Digital Liquidity Bonds configured as long-term capital instruments and Digital Liquidity Rebates configured as short-term participation instruments, monitor real-time transaction histories and yield accrual balances, track geographic allocation of tokens across designated jurisdictions, observe remaining multi-cycle transaction requirements for redemption eligibility, and submit redemption requests. The User Interface 202 may provide a unified dashboard consolidating the investor's portfolio, displaying active holdings, accrued yields, geographic distribution maps, and cycle completion progress indicators. The User Interface 202 may further enable third-party access authorization for designated individuals and allow investors to configure notification preferences for status change events. The User Interface 202 communicates downward to the Smart Contract Module 204, the Geofencing Enforcement Module 310, and the Transaction Processing and Economic Intelligence Module 222.

Still referring to FIG. 2, the Smart Contract Module 204 governs the automated execution of Digital Liquidity Instrument lifecycle events, including issuance, multi-cycle enforcement, and maturity-based redemption. The Smart Contract Module 204 receives instructions from the User Interface 202 and executes smart contract logic stored on the Blockchain Network 212, the smart contract logic being written in a smart contract programming language such as Solidity, Vyper, or Rust and compiled into bytecode for execution on a blockchain virtual machine. During issuance, the Smart Contract Module 204 mints one or more tokens on the Blockchain Network 212, each carrying on-chain metadata encoding the instrument-type identifier, the jurisdiction identifier, the maturity-condition set, the transaction-cycle counter initialized to zero, and the redemption-state flag initialized to a non-redeemable state. The Smart Contract Module 204 communicates downward to the Dual-Account Ledger 224, recording minted instruments in the Circulating Token Pool 226 and managing the structural segregation between the Circulating Token Pool 226 and the Digital Accrual Account 228. The Smart Contract Module 204 also manages the burn-to-unlock mechanism, which, upon autonomous determination that all predefined maturity conditions have been satisfied, atomically destroys the token on the Blockchain Network 212, transitions the redemption-state flag from the non-redeemable state to the redeemable state, and releases the corresponding accrued yield from the Digital Accrual Account 228 in a single irreversible blockchain transaction without human initiation.

Still referring to FIG. 2, the Geofencing Enforcement Module 310 is positioned in the middle tier of the DLI administration system 200 between the User Interface 202 and the Dual-Account Ledger 224, and ensures compliance with geographic circulation requirements for all Digital Liquidity Instrument transactions. The Geofencing Enforcement Module 310 performs real-time transaction location validation by evaluating each proposed transaction against permitted geographic boundaries using a plurality of location-related data sources including global positioning system data, IP-based geolocation data, device identifier data, and merchant or counterparty registration data. The module performs cross-source consistency analysis among these inputs to detect geographic evasion attempts including spoofing, proxy use, and synthetic routing at the protocol layer before blockchain confirmation. Transactions that fail jurisdictional validation or whose location-related inputs are inconsistent beyond a predefined threshold are rejected and prevented from recording on the Blockchain Network 212. The Geofencing Enforcement Module 310 communicates laterally with the Smart Contract Module 204 and the Transaction Processing and Economic Intelligence Module 222 to coordinate enforcement decisions and ensure that only jurisdictionally validated transactions proceed to cycle-count advancement and fee allocation.

Still referring to FIG. 2, the Transaction Processing and Economic Intelligence Module 222, labeled as TPE module in FIG. 2, is positioned alongside the Smart Contract Module 204 and the Geofencing Enforcement Module 310, and receives transaction data from the User Interface 202. The module processes each transaction by calculating the applicable transaction fee, determining the portion to be allocated as yield to the Digital Accrual Account 228, and distributing any applicable taxes or regulatory fees through the State Treasury Interface 314. The module also facilitates dynamic segregation of transaction-derived value between the Circulating Token Pool 226 and the Digital Accrual Account 228, adjusting allocation ratios in response to real-time economic data including aggregate transaction volume, average transaction value, active token counts, and economic indicators reported by the Data Analytics and AI Module 232. The Transaction Processing and Economic Intelligence Module 222 communicates downward to the Data Analytics and AI Module 232, providing transaction telemetry and economic performance data for predictive analytics and yield parameter recalibration.

Still referring to FIG. 2, the Dual-Account Ledger 224 is positioned below the Smart Contract Module 204 and maintains the structural segregation between circulating liquidity and yield accrual within the system. The Dual-Account Ledger 224 comprises two structurally and functionally distinct sub-ledgers maintained simultaneously by smart contract state variables. The first sub-ledger, the Circulating Token Pool 226, labeled as CTP (226) with the descriptor “Circulating tokens” in FIG. 2, holds all Digital Liquidity Instrument tokens in active economic circulation available for qualifying transactions within designated geographic jurisdictions. The Circulating Token Pool 226 may be implemented as a mapping data structure associating each instrument identifier with a circulation-state record comprising the current holder address, the current transaction-cycle counter value, and the current redemption-state flag value. The second sub-ledger, the Digital Accrual Account 228, labeled as DAA (228) with the descriptor “Yield accrual” in FIG. 2, independently accumulates transaction-derived value on behalf of each instrument holder. The Digital Accrual Account 228 may be implemented as a separate mapping data structure associating each instrument identifier or holder address with an accrued balance value. The smart contract architecture prevents the Digital Accrual Account 228 from depleting liquidity in the Circulating Token Pool 226, and prevents transfers within the Circulating Token Pool 226 from triggering any release of corresponding Digital Accrual Account 228 balances. This structural independence is enforced at the smart contract layer and cannot be circumvented by any participant, administrator, or treasury entity after contract deployment on the Blockchain Network 212. The Dual-Account Ledger 224 communicates downward to the Blockchain Network 212, which records all state changes to both sub-ledgers.

Still referring to FIG. 2, the Data Analytics and AI Module 232 is positioned alongside the Dual-Account Ledger 224 and receives data from the Transaction Processing and Economic Intelligence Module 222. The Data Analytics and AI Module 232 may be implemented as a set of machine learning models, statistical analysis engines, and data processing pipelines that ingest data from the Blockchain Network 212 including transaction records, token transfer events, and smart contract state changes, as well as off-chain data such as economic indicators and market conditions. The module continuously monitors transaction velocity and volume, dynamically adjusting yield parameters distributed to the Digital Accrual Account 228. The Data Analytics and AI Module 232 further performs risk-adjusted yield enforcement using predictive analytics, including regression models, time-series forecasting, neural networks, and ensemble methods, to recalibrate yield distribution thresholds and allocation ratios between the Circulating Token Pool 226 and the Digital Accrual Account 228 in response to both observed and anticipated changes in economic activity. The module also generates alerts related to yield distribution thresholds, compliance metrics, anomalous circulation patterns, and tokens approaching redemption eligibility.

Still referring to FIG. 2, the Blockchain Network 212 is positioned at the bottom tier of the DLI administration system 200 within a dashed boundary shared with the State Treasury Interface 314, and serves as the distributed ledger for recording all transactions, validating smart contract execution, and maintaining an immutable history of state changes. The Blockchain Network 212 may be a permissioned blockchain, a public blockchain, or a hybrid configuration, and may use consensus mechanisms such as proof of stake, proof of authority, or practical Byzantine fault tolerance. Each Digital Liquidity Instrument transaction may be recorded including sender and receiver wallet addresses, transaction value, timestamp, geographic jurisdiction code, and associated metadata such as the current transaction-cycle counter value and redemption-state flag. The Blockchain Network 212 communicates laterally with the State Treasury Interface 314 to coordinate reserve confirmation and fiat peg maintenance.

Still referring to FIG. 2, the State Treasury Interface 314 is positioned alongside the Blockchain Network 212 and facilitates interaction with state treasury systems to maintain a one-to-one peg between circulating tokens and fiat currency reserves. The State Treasury Interface 314 may be implemented as a secure application programming interface or encrypted communication channels between the application server and the treasury's financial management systems. The interface transmits data regarding total circulating token counts, aggregate pool value, and accrual account balances, and receives confirmations of sufficient fiat reserves. If a discrepancy is detected, the State Treasury Interface 314 may trigger corrective actions such as minting additional tokens backed by newly deposited fiat reserves or burning excess tokens. In emergency scenarios or market fluctuations, the State Treasury Interface 314 may enable rapid liquidity injections or controlled token burns to maintain economic stability.

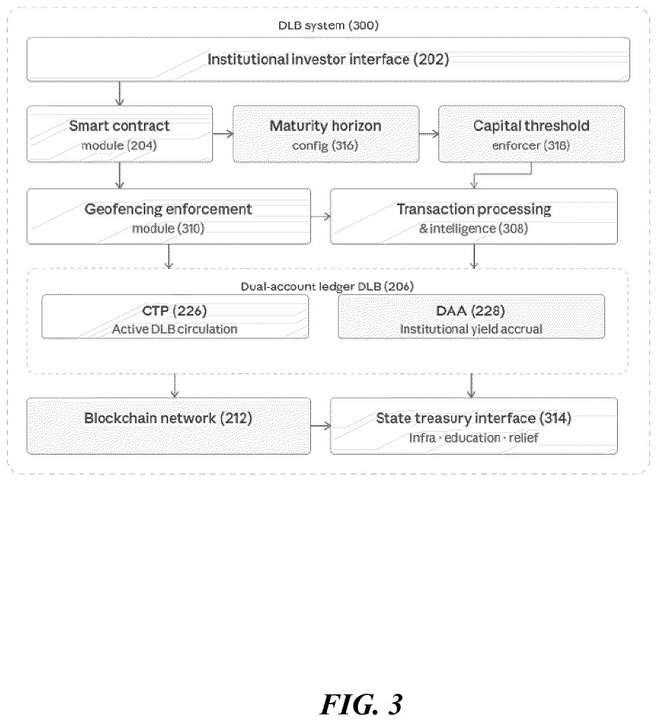

Referring now to FIG. 3, a block diagram of a Digital Liquidity Bond system 300, labeled as DLB system (300), is shown, according to some embodiments. The DLB system 300 represents a specific configuration optimized for the issuance, management, and redemption of Digital Liquidity Bonds as long-term capital instruments for institutional investors. FIG. 3 depicts an Institutional Investor Interface 202, a Smart Contract Module 204, a Maturity Horizon Configuration Module 316, a Capital Threshold Enforcer 318, a Geofencing Enforcement Module 310, a Transaction Processing and Economic Intelligence Module 308, a Dual-Account Ledger DLB 206 comprising a Circulating Token Pool 226 and a Digital Accrual Account 228, a Blockchain Network 212, and a State Treasury Interface 314.

Still referring to FIG. 3, the Institutional Investor Interface 202 is positioned at the top of the DLB system 300 and serves as the primary access point for institutional investors to interact with the DLB issuance and management infrastructure. The Institutional Investor Interface 202 enables institutional investors to create personalized accounts, browse available DLB offerings with associated parameters such as token denomination, expected yield range, maturity period, geographic circulation zone, and multi-cycle transaction requirements, specify capital amounts and investment horizons, and confirm purchases. The Institutional Investor Interface 202 may further provide a dashboard displaying active DLB holdings, accrued institutional yields, geographic allocation of tokens, and remaining cycle requirements for redemption eligibility. The Institutional Investor Interface 202 communicates downward to the Smart Contract Module 204, the Maturity Horizon Configuration Module 316, and the Capital Threshold Enforcer 318.

Still referring to FIG. 3, the Smart Contract Module 204 is positioned in the upper-middle tier and operates as described with reference to FIG. 2, governing Digital Liquidity Bond lifecycle events including issuance, multi-cycle enforcement, and burn-to-unlock redemption. The Smart Contract Module 204 mints Digital Liquidity Bond tokens each carrying on-chain metadata encoding the instrument-type identifier designating the instrument as a DLB, the jurisdiction identifier, the maturity-condition set, the transaction-cycle counter, and the redemption-state flag. The Smart Contract Module 204 communicates downward to the Geofencing Enforcement Module 310.

Still referring to FIG. 3, the Maturity Horizon Configuration Module 316, labeled as Maturity horizon config (316) in FIG. 3, is positioned in the upper-middle tier alongside the Smart Contract Module 204 and the Capital Threshold Enforcer 318, and receives configuration parameters from the Institutional Investor Interface 202. The Maturity Horizon Configuration Module 316 is configured to initialize and enforce instrument-type-specific maturity parameters at the time of Digital Liquidity Bond minting, encoding a first maturity horizon associated with an extended maturity period and structured yield parameters suited to large-scale institutional capital deployment. The maturity parameters may include a minimum transaction-cycle counter threshold, a time-based maturity timestamp, a geographic circulation threshold, and an accrued-value threshold, each encoded as machine-readable conditions within the instrument's maturity-condition set. The Maturity Horizon Configuration Module 316 communicates laterally with the Smart Contract Module 204 and the Capital Threshold Enforcer 318 to ensure consistent application of maturity parameters and capital requirements during issuance.

Still referring to FIG. 3, the Capital Threshold Enforcer 318 is positioned in the upper-middle tier alongside the Smart Contract Module 204 and the Maturity Horizon Configuration Module 316. The Capital Threshold Enforcer 318 validates that each proposed DLB purchase satisfies a minimum capital threshold for institutional investors. When a proposed purchase amount fails to satisfy the applicable threshold, the Capital Threshold Enforcer 318 prevents issuance and transmits a notification to the Institutional Investor Interface 202 indicating the shortfall. The Capital Threshold Enforcer 318 communicates laterally with the Maturity Horizon Configuration Module 316 and the Smart Contract Module 204 to coordinate validation during the issuance process.

Still referring to FIG. 3, the Geofencing Enforcement Module 310 is positioned in the middle tier below the Smart Contract Module 204 alongside the Transaction Processing and Economic Intelligence Module 308. The Geofencing Enforcement Module 310 enforces geo-fencing restrictions on all DLB transactions using multi-source location validation and cross-source consistency analysis as described with reference to FIG. 2, evaluating each proposed transaction against permitted geographic boundaries and rejecting transactions that fail jurisdictional validation. The module also performs geographic-based token velocity tracking, monitoring the rate at which DLB tokens circulate within each designated jurisdiction over defined time periods, and reports velocity data to the Transaction Processing and Economic Intelligence Module 308 for use in yield calculations. The Geofencing Enforcement Module 310 communicates downward to the Dual-Account Ledger DLB 206.

Still referring to FIG. 3, the Transaction Processing and Economic Intelligence Module 308 is positioned alongside the Geofencing Enforcement Module 310 and combines transaction processing with economic analysis. The module calculates applicable transaction fees, determines allocation between the Circulating Token Pool 226 and the Digital Accrual Account 228, and distributes any applicable taxes or regulatory fees. The economic intelligence functions include real-time monitoring of investment yields, token velocity, aggregate transaction volumes, and economic performance indicators. The module utilizes machine learning techniques including time-series forecasting, regression analysis, and predictive modeling to dynamically adjust yield parameters and perform risk-adjusted yield enforcement, ensuring that yield obligations remain sustainable and aligned with actual economic performance. The module communicates downward to the Dual-Account Ledger DLB 206.

Still referring to FIG. 3, the Dual-Account Ledger DLB 206 is positioned below the Geofencing Enforcement Module 310 and the Transaction Processing and Economic Intelligence Module 308 and maintains the structural segregation between active DLB circulation and institutional yield accrual. The Dual-Account Ledger DLB 206 functions consistently with the Dual-Account Ledger 224 described with reference to FIG. 2. The Circulating Token Pool 226, labeled as CTP (226) with the descriptor “Active DLB circulation” in FIG. 3, maintains DLB tokens in active economic circulation within designated jurisdictions. The Digital Accrual Account 228, labeled as DAA (228) with the descriptor “Institutional yield accrual” in FIG. 3, independently accumulates transaction-derived value for each institutional instrument holder. The Dual-Account Ledger DLB 206 is specifically configured to handle the longer maturity horizons and higher capital denominations of institutional DLB instruments. The smart contract architecture prevents the Digital Accrual Account 228 from depleting liquidity in the Circulating Token Pool 226. The Dual-Account Ledger DLB 206 communicates downward to the Blockchain Network 212.

Still referring to FIG. 3, the Blockchain Network 212 is positioned at the bottom tier within a dashed boundary shared with the State Treasury Interface 314, and operates as described with reference to FIG. 2. The State Treasury Interface 314 is labeled with the descriptor “Infra⋅education⋅relief” in FIG. 3, indicating that within the DLB system 300 it facilitates the issuance of Digital Liquidity Bonds for targeted public initiatives including public infrastructure financing for transportation networks, renewable energy development, and broadband expansion, education and workforce development funding for tuition assistance and vocational training programs, and disaster relief and recovery efforts. The State Treasury Interface 314 manages the one-to-one fiat peg and ensures liquidity stability for circulating DLB tokens, transmitting circulation data and receiving reserve confirmations from state or municipal treasury systems.

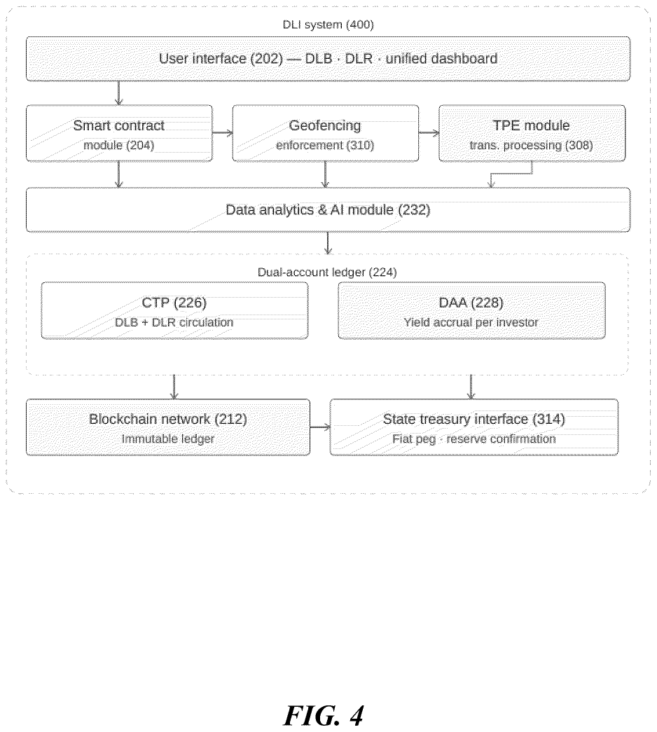

Referring now to FIG. 4, a block diagram of a Digital Liquidity Instrument system 400, labeled as DLI system (400), is shown, according to some embodiments. The DLI system 400 represents a comprehensive configuration supporting both Digital Liquidity Bonds and Digital Liquidity Rebates within a single unified infrastructure. FIG. 4 depicts a User Interface 202, a Smart Contract Module 204, a Geofencing Enforcement Module 310, a Transaction Processing and Economic Intelligence Module 308, a Data Analytics and AI Module 232, a Dual-Account Ledger 224 comprising a Circulating Token Pool 226 and a Digital Accrual Account 228, a Blockchain Network 212, and a State Treasury Interface 314.

Still referring to FIG. 4, the User Interface 202 is positioned at the top of the DLI system 400 and is labeled “User interface (202)—DLB⋅DLR⋅unified dashboard,” indicating support for both instrument types through a single consolidated view. The User Interface 202 may provide a unified portfolio display showing active DLB and DLR holdings alongside their respective yield accruals, cycle completion status, and geographic allocation data. Institutional investors may subscribe to DLBs carrying longer maturity periods and higher capital requirements, while retail investors may purchase DLRs with shorter maturity periods and lower capital thresholds, both through the same interface. The User Interface 202 supports account creation, investment initiation, transaction monitoring, notification configuration, third-party access authorization, and redemption request submission for both tiers. The User Interface 202 communicates downward to the Smart Contract Module 204, the Geofencing Enforcement Module 310, and the Transaction Processing and Economic Intelligence Module 308.

Still referring to FIG. 4, the Smart Contract Module 204, the Geofencing Enforcement Module 310, and the Transaction Processing and Economic Intelligence Module 308, labeled as TPE module trans. processing (308), are positioned in the upper-middle tier. The Smart Contract Module 204 governs the entire lifecycle of both DLBs and DLRs from issuance through burn-to-unlock redemption. The Geofencing Enforcement Module 310 enforces geographic restrictions for both instrument types using multi-source location validation and cross-source consistency analysis as described with reference to FIG. 2. The Transaction Processing and Economic Intelligence Module 308 performs fee calculation, value allocation between the sub-ledgers, and economic intelligence functions for both instrument types as described with reference to FIG. 3. All three modules communicate downward to the Data Analytics and AI Module 232.

Still referring to FIG. 4, the Data Analytics and AI Module 232 is positioned in the middle tier, receiving data from the three upper-tier modules. The module continuously monitors transaction velocity, geographic distribution, and circulation patterns across both DLB and DLR instrument types to autonomously recalibrate allocation ratios, yield distribution thresholds, and risk parameters without human initiation of individual adjustments. The module utilizes machine learning models including time-series forecasting, regression analysis, and neural networks trained on historical transaction data and economic indicators. The Data Analytics and AI Module 232 communicates downward to the Dual-Account Ledger 224.

Still referring to FIG. 4, the Dual-Account Ledger 224 is positioned below the Data Analytics and AI Module 232. The Circulating Token Pool 226, labeled as CTP (226) with the descriptor “DLB+DLR circulation” in FIG. 4, maintains both DLB and DLR tokens in active circulation, both subject to the same geo-fencing restrictions and multi-cycle transaction requirements. The Digital Accrual Account 228, labeled as DAA (228) with the descriptor “Yield accrual per investor” in FIG. 4, independently accumulates transaction-derived value for each individual instrument holder, maintaining separate yield accrual records for DLB and DLR holdings. The protocol-layer segregation between the sub-ledgers prevents accrual obligations from depleting active circulation liquidity. The Dual-Account Ledger 224 communicates downward to the Blockchain Network 212 and the State Treasury Interface 314.

Still referring to FIG. 4, the Blockchain Network 212 is positioned at the bottom tier with the descriptor “Immutable ledger” in FIG. 4, recording all DLB and DLR transactions. The State Treasury Interface 314 is positioned alongside with the descriptor “Fiat peg⋅reserve confirmation” in FIG. 4, maintaining reserve correspondence between the aggregate circulating supply in the Circulating Token Pool 226 and backing fiat reserves held by the state treasury for both instrument types. The DLI system 400 thereby enables a multi-tiered economic participation framework in which institutional and retail investors share the same Circulating Token Pool, Blockchain Network, enforcement mechanisms, and state-backed treasury integration, while maintaining separate yield accrual records within their respective Digital Accrual Accounts in the Dual-Account Ledger 224.

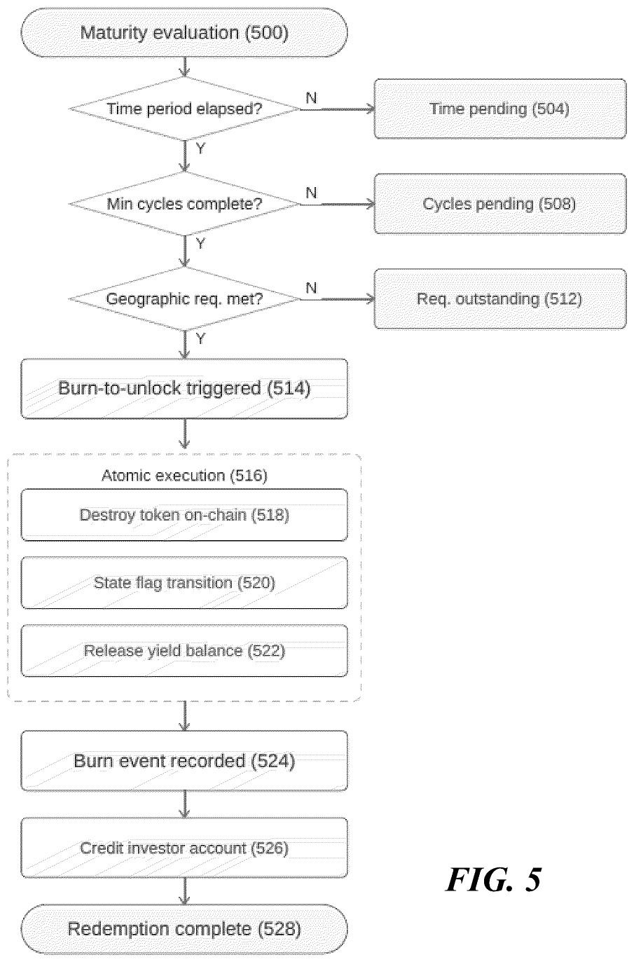

Referring now to FIG. 5, a flow diagram illustrating an example lifecycle process 500 for maturity evaluation and burn-to-unlock redemption of a Digital Liquidity Instrument is shown, according to some embodiments. The process begins at a maturity evaluation step 500, depicted as a rounded start node labeled “Maturity evaluation (500),” at which the smart contract logic evaluates whether the maturity-condition set encoded in the on-chain metadata of a given Digital Liquidity Instrument has been satisfied. The evaluation may be triggered autonomously in response to a qualifying transaction event, a redemption request submitted through the User Interface 202, or a periodic evaluation cycle.

Still referring to FIG. 5, the process proceeds through three sequential decision diamonds. The first evaluates whether a time-based maturity timestamp encoded in the maturity-condition set has been reached; if not (N branch), the process proceeds to a time pending step 504 and terminates until a subsequent evaluation cycle. If the time period has elapsed (Y branch), a second decision diamond evaluates whether the transaction-cycle counter has reached the minimum threshold; if not (N branch), the process proceeds to a cycles pending step 508 and terminates until additional qualifying transactions occur. If the minimum cycles are complete (Y branch), a third decision diamond evaluates whether geographic circulation thresholds have been met; if not (N branch), the process proceeds to a requirements outstanding step 512 and terminates until the geographic conditions are satisfied. At each pending or outstanding step, the instrument remains in its non-redeemable state.

Still referring to FIG. 5, when all three conditions are satisfied (Y branch from the third decision diamond), the process proceeds to a burn-to-unlock triggered step 514, followed by an atomic execution block 516 depicted within a dashed boundary labeled “Atomic execution (516).” The atomic execution block 516 encompasses three operations executed together within a single irreversible blockchain transaction: a destroy token on-chain step 518, at which the smart contract deletes or deactivates the instrument's entry in the Circulating Token Pool mapping, removing it from active circulation and preventing further transfers; a state flag transition step 520, at which the redemption-state flag is updated from the non-redeemable to the redeemable enumeration value, creating an immutable on-chain record of the transition; and a release yield balance step 522, at which the accumulated balance from the Digital Accrual Account mapping entry is transferred to a designated redemption address or settlement ledger entry specified by the instrument holder. The atomicity ensures all three state changes commit together or none commit, such that no partial execution state is possible.

Still referring to FIG. 5, following the atomic execution block 516, the process proceeds to a burn event recorded step 524, at which the completed burn-to-unlock transaction is recorded on the Blockchain Network as an immutable, auditable event including the identity of the destroyed token, the final transaction-cycle counter value, the state flag transition, and the released amount. The process then proceeds to a credit investor account step 526, at which the application server credits the investor's account with the redeemed value and transmits a confirmation notification through the User Interface 202. The process concludes at a redemption complete step 528, depicted as a rounded terminal node, at which the Digital Liquidity Instrument's lifecycle has been fully concluded and the instrument has been permanently removed from circulation.

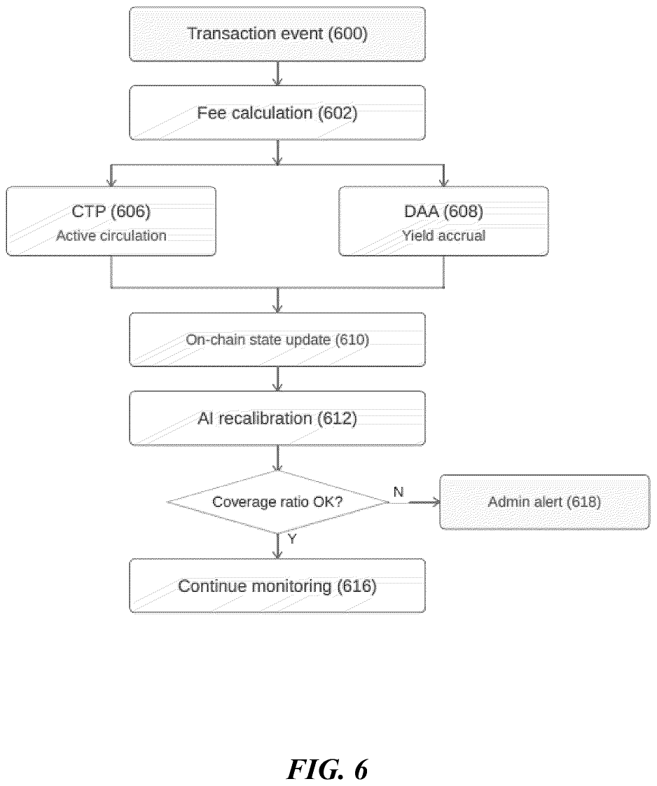

Referring now to FIG. 6, a flow diagram illustrating an example process for smart-contract-enforced segregation of transaction-derived value between a Circulating Token Pool and a Digital Accrual Account within a Dual-Account Ledger is shown, according to some embodiments. The process begins at a transaction event step 600, at which a validated transaction involving a Digital Liquidity Instrument token has been received, having already satisfied jurisdictional validation by the Geofencing Enforcement Module 310.

Still referring to FIG. 6, the process proceeds to a fee calculation step 602, at which the Transaction Processing and Economic Intelligence Module extracts transaction attributes including the transaction value, instrument type, jurisdiction code, and applicable fee schedules, and invokes an allocation rules engine to determine the applicable allocation ratio. The process then splits into two parallel allocation paths: a CTP step 606, labeled “CTP (606) Active circulation,” at which the portion allocated to the Circulating Token Pool is applied, maintaining the instrument in active circulation and preserving liquidity for subsequent qualifying transactions; and a DAA step 608, labeled “DAA (608) Yield accrual,” at which the portion allocated to the Digital Accrual Account is applied, independently accumulating yield for the instrument holder. The structural independence of these paths is enforced at the smart contract layer such that increments to the Digital Accrual Account do not reduce Circulating Token Pool liquidity, and vice versa.

Still referring to FIG. 6, the process proceeds to an on-chain state update step 610, at which updated balance values for both sub-ledgers are written to the smart contract state variables on the Blockchain Network along with audit and telemetry records. The process then proceeds to an AI recalibration step 612, at which the Data Analytics and AI Module evaluates whether recalibration of allocation parameters is warranted based on cumulative economic indicators and predictive analytics, applying machine learning models to assess whether the current allocation ratio remains optimal given observed and anticipated conditions.

Still referring to FIG. 6, the process proceeds to a decision diamond evaluating whether the coverage ratio is satisfactory, the coverage ratio representing the relationship between the aggregate circulating token supply and backing fiat reserves or between accrual obligations and available yield coverage. If satisfactory (Y branch), the process proceeds to a continue monitoring step 616 and awaits the next transaction event. If not satisfactory (N branch), the process proceeds to an admin alert step 618, at which an alert is generated for system administrators indicating that the coverage ratio has fallen below an acceptable threshold and that corrective action may be required, such as adjusting allocation ratios, triggering treasury reserve confirmations, or initiating controlled token burns.

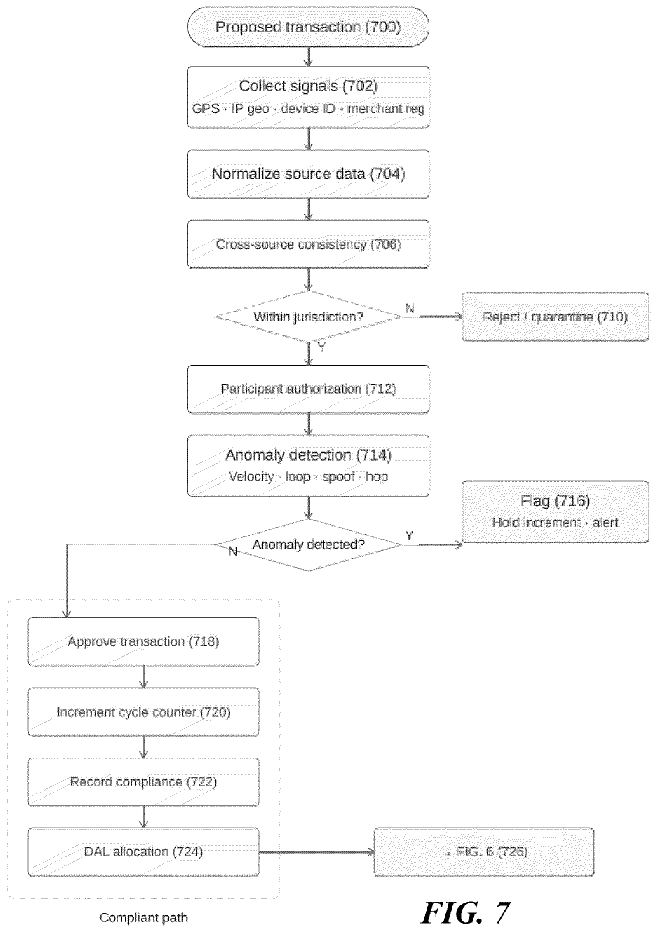

Referring now to FIG. 7, a flow diagram illustrating an example process for multi-source geographic validation, jurisdictional compliance enforcement, and anomalous-circulation detection for Digital Liquidity Instrument transactions is shown, according to some embodiments. The process begins at a proposed transaction step 700, at which a transaction involving a Digital Liquidity Instrument token has been proposed but not yet validated or confirmed on the Blockchain Network.

Still referring to FIG. 7, the process proceeds to a collect signals step 702, labeled with the descriptor “GPS⋅IP geo⋅device ID⋅merchant reg.,” at which location and identity data is gathered from a plurality of sources including global positioning system data, IP-based geolocation data, device identifier data, and merchant or counterparty registration data. The collection of multiple independent sources enables cross-source verification and detection of attempts to circumvent geographic restrictions through spoofing or proxy use. The process then proceeds to a normalize source data step 704, at which the raw signals are standardized into a common format by converting GPS coordinates into jurisdiction codes, resolving IP geolocation to geographic boundary identifiers, and mapping device and merchant data to jurisdiction codes consistent with the instrument's on-chain metadata.

Still referring to FIG. 7, the process proceeds to a cross-source consistency step 706, at which the Geofencing Enforcement Module performs cross-source consistency analysis among the normalized inputs to detect discrepancies that may indicate geographic evasion attempts, including conflicting jurisdiction indications across data sources or patterns suggesting virtual private network, proxy server, or GPS spoofing use. The process then proceeds to a jurisdictional decision diamond evaluating whether the proposed transaction falls within the permitted geographic boundaries. If not (N branch), the process proceeds to a reject or quarantine step 710, at which the transaction is rejected and prevented from recording on the Blockchain Network, or alternatively quarantined for manual review. The rejected or quarantined transaction does not result in cycle-count advancement or accrual allocation.

Still referring to FIG. 7, if the transaction is within the permitted jurisdiction (Y branch), the process proceeds to a participant authorization step 712, at which the system verifies that the sender and receiver are authorized ecosystem participants with accounts in good standing, having completed any required identity verification and compliance procedures. The process then proceeds to an anomaly detection step 714, labeled with the descriptor “Velocity⋅loop⋅spoof⋅hop,” at which the system evaluates the transaction and the instrument's recent history for patterns indicating fraudulent activity or artificial cycle inflation. Anomalous patterns evaluated include velocity irregularities inconsistent with genuine economic activity, looping transfers between affiliated entities designed to artificially inflate the cycle counter, spoofing indicators suggesting falsified location or identity data, and jurisdiction-hopping patterns inconsistent with normal commercial activity.

Still referring to FIG. 7, the process proceeds to an anomaly decision diamond. If an anomaly is detected (Y branch), the process proceeds to a flag step 716, labeled “Hold increment⋅alert,” at which cycle-count advancement is suspended for the corresponding instrument and an alert is generated for system administrators or compliance officers. The flagged transaction may be held pending further review or subjected to enhanced verification. If no anomaly is detected (N branch), the process proceeds along a compliant path depicted within a dashed boundary comprising four sequential operations: an approve transaction step 718, at which the transaction is confirmed for blockchain recording; an increment cycle counter step 720, at which the on-chain transaction-cycle counter is incremented by one; a record compliance step 722, at which jurisdictional validation results, authorization confirmation, and anomaly detection outcomes are recorded as part of the immutable audit trail on the Blockchain Network; and a DAL allocation step 724, at which the system initiates allocation of transaction-derived value between the Circulating Token Pool and the Digital Accrual Account. The DAL allocation step 724 communicates to a cross-reference step 726, labeled “→FIG. 6 (726),” indicating that the detailed allocation, state update, recalibration, and coverage evaluation process continues as described with reference to FIG. 6.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for enforcing autonomous dual-ledger state segregation and geographically constrained multi-cycle lifecycle management of blockchain-based digital liquidity instruments, the system comprising: a blockchain network comprising one or more nodes configured to maintain an immutable ledger of token state changes; a smart contract module executable in association with the blockchain network and configured to mint, monitor, and update one or more digital liquidity instruments, each digital liquidity instrument comprising on-chain metadata including an instrument-type identifier, a jurisdiction identifier, a maturity-condition set, a transaction-cycle counter, and a redemption-state flag; a dual-account ledger comprising a first sub-ledger configured to maintain one or more of the digital liquidity instruments in active economic circulation, and a second sub-ledger configured to accumulate transaction-derived accrual amounts independently from the first sub-ledger such that accrual obligations do not deplete liquidity available for active circulation; a geo-fencing enforcement module configured to evaluate a proposed transfer of a digital liquidity instrument against one or more permitted geographic jurisdictions and to prevent recording of the proposed transfer on the blockchain network when the proposed transfer fails jurisdictional validation; a transaction-processing module configured to detect qualifying transaction events involving the digital liquidity instruments, increment the transaction-cycle counter for a corresponding digital liquidity instrument when a qualifying transaction event satisfies one or more circulation rules, and allocate at least a portion of transaction-derived value to the second sub-ledger while maintaining the corresponding digital liquidity instrument in the first sub-ledger for continued circulation; a burn-to-unlock control configured to determine whether the maturity-condition set for a given digital liquidity instrument has been satisfied and, upon satisfaction of the maturity-condition set, to atomically remove the given digital liquidity instrument from circulation, transition the redemption-state flag of the given digital liquidity instrument from a non-redeemable state to a redeemable state, and release an accrued amount associated with the given digital liquidity instrument from the second sub-ledger; and a treasury interface configured to communicate with a state treasury system to maintain reserve correspondence between circulating digital liquidity instruments and backing fiat reserves.

2. The system of claim 1, wherein the geo-fencing enforcement module is configured to determine jurisdictional compliance based on a plurality of location-related inputs comprising at least two of: global positioning system (GPS) data, internet protocol (IP)-based geolocation data, device identifier data, merchant or counterparty registration data, account jurisdiction data, or validator-region data.

3. The system of claim 2, wherein the geo-fencing enforcement module is further configured to perform cross-source consistency analysis among the plurality of location-related inputs and to reject, quarantine, or delay a proposed transfer when the plurality of location-related inputs are inconsistent beyond a predefined threshold.

4. The system of claim 1, wherein the digital liquidity instruments comprise at least: a first instrument type comprising a digital liquidity bond (DLB) associated with a first maturity horizon, a first capital threshold, and a first accrual profile; and a second instrument type comprising a digital liquidity rebate (DLR) associated with a second maturity horizon, a second capital threshold, and a second accrual profile different from the first maturity horizon, first capital threshold, and first accrual profile.

5. The system of claim 1, wherein the burn-to-unlock control is configured to execute the removal from circulation, the transition of the redemption-state flag, and the release of the accrued amount as a single irreversible blockchain transaction.

6. The system of claim 1, further comprising an anomaly-detection module configured to detect one or more anomalous circulation patterns comprising repeated circular transfers, affiliated-entity looping, artificial cycle inflation, jurisdiction-hopping, velocity irregularities, or geographic spoofing indicators, and to suspend cycle-count advancement for a corresponding digital liquidity instrument responsive to the detected anomalous circulation pattern.

7. The system of claim 1, wherein the smart contract module is further configured to initialize, at issuance of each digital liquidity instrument, on-chain metadata comprising the instrument-type identifier, a maturity timestamp or maturity rule set, the transaction-cycle counter, the jurisdiction identifier, the redemption-state flag, and a pointer or reference corresponding to an accrual balance maintained in the second sub-ledger.

8. A computer-implemented method for enforcing autonomous dual-ledger state segregation and geographically constrained multi-cycle lifecycle management of blockchain-based digital liquidity instruments, the method comprising: minting, by a smart contract module associated with a blockchain network, one or more digital liquidity instruments, each digital liquidity instrument being recorded with metadata including an instrument-type identifier, a jurisdiction identifier, a maturity-condition set, a transaction-cycle counter, and a redemption-state flag; recording each minted digital liquidity instrument in a first sub-ledger of a dual-account ledger for active economic circulation; receiving a proposed transaction involving a selected digital liquidity instrument; performing jurisdictional validation of the proposed transaction using a geo-fencing enforcement module; when the proposed transaction satisfies jurisdictional validation and one or more qualifying transaction rules: recording the proposed transaction on the blockchain network, incrementing the transaction-cycle counter of the selected digital liquidity instrument, and allocating at least a portion of transaction-derived value to a second sub-ledger of the dual-account ledger configured for accrual storage independent of the first sub-ledger; repeating validation and counter-increment operations across a plurality of qualifying transactions while maintaining the selected digital liquidity instrument in a non-redeemable circulation state; evaluating whether the maturity-condition set of the selected digital liquidity instrument has been satisfied based on at least one of a required number of qualifying transaction cycles, a time threshold, a geographic circulation threshold, or an accrued-value threshold; and when the maturity-condition set is satisfied, atomically removing the selected digital liquidity instrument from circulation, changing the redemption-state flag from the non-redeemable state to a redeemable state, and releasing an accrued amount from the second sub-ledger for redemption or settlement.

9. The method of claim 8, wherein performing jurisdictional validation comprises collecting at least two location-related inputs selected from GPS data, IP geolocation data, device identifier data, merchant registration data, account jurisdiction data, and validator-region data.

10. The method of claim 9, further comprising comparing the at least two location-related inputs for cross-source consistency and rejecting, quarantining, or delaying the proposed transaction when the at least two location-related inputs are inconsistent beyond a predefined threshold.

11. The method of claim 8, wherein minting the one or more digital liquidity instruments comprises minting: a first instrument type comprising a DLB having a first maturity horizon, first capital threshold, and first accrual profile; and a second instrument type comprising a DLR having a second maturity horizon, second capital threshold, and second accrual profile distinct from the first maturity horizon, first capital threshold, and first accrual profile.

12. The method of claim 8, wherein atomically removing the selected digital liquidity instrument from circulation, changing the redemption-state flag, and releasing the accrued amount comprises executing the removing, changing, and releasing within a single irreversible blockchain transaction.

13. The method of claim 8, further comprising detecting an anomalous circulation pattern associated with the selected digital liquidity instrument, the anomalous circulation pattern comprising one or more of repeated circular transfers, affiliated-entity looping, artificial cycle inflation, jurisdiction-hopping, velocity irregularities, or geographic spoofing indicators, and, responsive thereto, preventing increment of the transaction-cycle counter.

14. The method of claim 8, further comprising generating, based on transaction data associated with the selected digital liquidity instrument, an analytics input for an intelligence module configured to recalculate one or more of an allocation ratio, a maturity parameter, an accrual parameter, or a redemption pacing parameter for subsequent transactions.

15. A non-transitory computer-readable storage medium storing instructions that, when executed by one or more processors, cause the one or more processors to perform operations comprising: instantiating a smart contract-controlled digital liquidity instrument on a blockchain network, the digital liquidity instrument comprising machine-readable metadata including an instrument-type identifier, a jurisdiction identifier, a maturity-condition set, a transaction-cycle counter, and a redemption-state flag; maintaining the digital liquidity instrument in a first sub-ledger of a dual-account ledger for active circulation and maintaining transaction-derived accrual amounts associated with the digital liquidity instrument in a second sub-ledger separate from the first sub-ledger; validating, for each proposed transfer of the digital liquidity instrument, whether the proposed transfer satisfies a geo-fencing rule associated with the jurisdiction identifier; preventing blockchain confirmation of the proposed transfer when the geo-fencing rule is not satisfied; upon determining that the proposed transfer satisfies the geo-fencing rule and one or more qualifying transaction rules: recording the proposed transfer on the blockchain network, incrementing the transaction-cycle counter, and updating the second sub-ledger to reflect transaction-derived accrual associated with the proposed transfer; evaluating whether the maturity-condition set has been satisfied for the digital liquidity instrument; and upon determining that the maturity-condition set has been satisfied, executing a burn-to-unlock operation comprising removing the digital liquidity instrument from active circulation, transitioning the redemption-state flag from a non-redeemable state to a redeemable state, and releasing an accrued amount from the second sub-ledger in association with redemption or settlement of the digital liquidity instrument.

16. The non-transitory computer-readable storage medium of claim 15, wherein validating whether the proposed transfer satisfies the geo-fencing rule comprises evaluating a plurality of location-related inputs including at least two of GPS data, IP geolocation data, device identifier data, merchant registration data, account jurisdiction data, or validator-region data.

17. The non-transitory computer-readable storage medium of claim 16, wherein the operations further comprise comparing the plurality of location-related inputs for cross-source consistency and preventing blockchain confirmation of the proposed transfer when the plurality of location-related inputs are inconsistent beyond a predefined threshold.

18. The non-transitory computer-readable storage medium of claim 15, wherein instantiating the smart contract-controlled digital liquidity instrument comprises initializing: a first instrument type comprising a DLB associated with a first maturity horizon, a first capital threshold, and a first accrual profile; or a second instrument type comprising a DLR associated with a second maturity horizon, a second capital threshold, and a second accrual profile distinct from the first maturity horizon, first capital threshold, and first accrual profile.

19. The non-transitory computer-readable storage medium of claim 15, wherein the burn-to-unlock operation comprises an irreversible blockchain transaction that, without human intervention after satisfaction of the maturity-condition set, removes the digital liquidity instrument from active circulation, transitions the redemption-state flag, and releases the accrued amount from the second sub-ledger.

20. The non-transitory computer-readable storage medium of claim 15, wherein the operations further comprise detecting one or more anomalous circulation patterns comprising repeated circular transfers, affiliated-entity looping, artificial cycle inflation, jurisdiction-hopping, velocity irregularities, or geographic spoofing indicators and, responsive thereto, preventing cycle-count advancement or requiring secondary validation before blockchain confirmation.

21. The non-transitory computer-readable storage medium of claim 15, wherein the operations further comprise issuing one or more of the digital liquidity instruments to fund a public infrastructure project, wherein the geo-fencing restrictions are configured to ensure that associated capital circulates within geographic areas associated with the infrastructure project throughout an active project lifecycle.

22. The non-transitory computer-readable storage medium of claim 15, wherein the operations further comprise issuing one or more of the digital liquidity instruments for disaster relief or emergency recovery, wherein the geo-fencing restrictions are configured to ensure that associated capital remains within geographic areas affected by the relevant disaster or emergency event.

23. The non-transitory computer-readable storage medium of claim 15, wherein the operations further comprise issuing one or more of the digital liquidity instruments as state-subsidized instruments for education or workforce development funding, wherein yields accumulate in the second sub-ledger based on transactional activity related to qualifying educational or vocational expenditures.
